(19) United States
(12) Patent Application Publication
(10) Pub. No.: US 2017/0083897 A1
(43) Pub. Date: Mar. 23, 2017

(54) MOBILE PURCHASE REWARDS

(71) Applicant: BBVA Compass Bancshares, Inc., Houston, TX (US)

(72) Inventors: Mehmet Sezgin, Istanbul (TR); Toga Koktuna, Istanbul (TR); Ryan Kraynick, Houston, TX (US); David Thomas, Houston, TX (US); Samuel Marshall, Birmingham, AL (US); Jeff Cisewski, Atlanta, GA (US); Melissa Jankowski, Houston, TX (US)

(73) Assignee: BBVA Compass Bancshares, Inc., Houston, TX (US)

(21) Appl. No.: 15/270,815

(22) Filed: Sep. 20, 2016

Related U.S. Application Data
(60) Provisional application No. 62/221,481, filed on Sep. 21, 2015.

(51) Int. Cl. G06Q 20/32; G06Q 20/36; H04L 12/58

(52) U.S. Cl. CPC G06Q 20/3221; H04L 51/066; G06Q 20/36

(57) ABSTRACT

Embodiments of methods, apparatuses and systems for mobile purchase rewards are described. An embodiment of a method includes receiving confirmation of a transaction that triggers accrual of a reward unit at a processing device. Such an embodiment may further include updating a reward account in response to the transaction using the processing device. Additionally, the method may include notifying the holder of the reward account, via an interface to a mobile communication device, that the reward account has been updated.

### PRIORITY

This application claims priority to U.S. provisional patent application No. 62/221,481, filed on Sep. 21, 2015, the entire content of which is incorporated herein by reference.

### FIELD

This disclosure relates generally to mobile purchase applications, and more specifically, to mobile purchase rewards.

### BACKGROUND

A loyalty rewards plan is a program offered by companies, including financial institutions, to provide value rewards to customers in exchange for the customers' use of the credit card for purchases. Other institutions, such as airlines, retail stores, grocery stores, and the like may offer loyalty rewards programs as well. Loyalty rewards may include issuance of reward points to a value account, cash back to the purchaser's account, chances to earn giveaway prizes, reduced account fees, and many other similar incentive programs recognizable to one of ordinary skill in the art.

Loyalty rewards programs typically involve accumulating reward points, cash back, or other rewards value units in a tally or account associated with the user. For example, a credit card company may offer airline miles in an airline rewards account as a reward for purchases with the credit card. The airline miles may be held in an account maintained by the airline, the credit card company, or a third party rewards manager. The account may be associated with the credit card user's credit card account, and accessible for purchases through the airline, or other affiliated rewards outlets. Typically, the credit card user receives a monthly statement of accrued rewards units. In some cases, the user may access the rewards account via an online Internet-accessible interface.

Conversion of the rewards units typically involves use of a paper or online order catalogue, online or telephone booking system, or the like for redemption of rewards units for goods, services, travel or transportation. In some programs, the rewards units may be redeemed for account credits or cash using a telephone or online interface system.

There are several problems associated with traditional loyalty rewards programs. For example, customers typically need to wait for monthly accrual statements to be able to use rewards points. Even if points are accrued in the account before the monthly statements, customers typically have limited access to rewards account balances, and have to take special steps to authenticate or request access to rewards balances. For example, customers may be required to use login credentials to access a separate rewards website. Finally, customers typically have very limited options with respect to redemption of rewards units, and the interfaces for making purchases are typically limited, and purchases are often not reflected in account balances until the end of the statement period.

A mobile purchase application is an application program or mobile ‘app’ that facilitates transfer of value or monetary funds from a user's bank account to another party, such as a retailer, via a banking interface accessible via a mobile data device. A mobile data device may include, for example, telephone devices having a cellular or mobile data interface, such as smartphones. Other mobile data devices may include tablet computing devices, Personal Data Assistants (PDAs), smart watches or wearable data devices, and the like. Commonly, such applications are referred to as mobile wallet apps.

A mobile wallet app may operate to enable a purchase transaction by communicating banking information to a point of sale system or online retailing system. The purchase transaction may be conducted in a way that is similar to a credit card transaction. Many financial institutions that offer credit card accounts provide loyalty rewards plans. Accordingly, there is a need for streamlined access to loyalty rewards plans via a mobile wallet app.

### SUMMARY

Embodiments of methods, apparatuses and systems for mobile purchase rewards are described. An embodiment of a method includes receiving confirmation of a transaction that triggers accrual of a reward unit at a processing device. Such an embodiment may further include updating a reward account in response to the transaction using the processing device. Additionally, the method may include notifying the holder of the reward account, via an interface to a mobile communication device, that the reward account has been updated.

In a further embodiment, the mobile communication device is configured to operate according to instructions of a mobile banking application. Additionally, the mobile banking application may include a mobile wallet application configured to facilitate purchases via the mobile communication device. In one embodiment, notifying is performed via a graphical user interface screen of the mobile banking application. Alternatively, notifying is performed via a push notification from the mobile banking application. In another embodiment, notifying comprises sending a text message to the mobile communication device. In still another embodiment, notifying comprises sending an electronic mail message.

The method may also include prompting the holder of the account to redeem the accrued reward units via the mobile communication device. In such an embodiment, the method may additionally include communicating confirmation of reward redemption in response to the account holder redeeming accrued reward units via the mobile communication device.

Another embodiment of a method may include receiving, at a user interface of a mobile communication device, a command to conduct a transaction. Such an embodiment may also include processing the command at a processing device coupled to the user interface. Additionally, the method may include receiving updated reward account information from a reward account server over a communication interface. The method may also include communicating the updated reward account information via a user interface in response to the received reward account information.

In a further embodiment, the method includes sending a confirmation of the transaction to a remote reward account server via a communication interface coupled to the processing device. The method may also include receiving, at the user interface, a command to redeem reward units from the reward account. Additionally, the method may include processing the command to redeem the reward units. In such an embodiment, the method may include communicating information, in response to the command to redeem reward units, to the reward account server. The method may also include receiving updated reward account information in response to the redeemed reward units.

An embodiment of an apparatus may include an input interface configured to receive confirmation of a transaction that triggers accrual of a reward unit, a processing device configured to update a reward account in response to the transaction, and an output interface coupled to a remote mobile communication device, the output interface configured to notify the holder of the reward account, via the mobile communication device, that the reward account has been updated.

Another embodiment of an apparatus may include a user interface configured to receive a command to conduct a transaction, a processing device coupled to the user interface device, the processing device configured to process transaction in response to a user command, a communication interface configured to receive updated reward account information from a reward account server in response to the processed transaction, and a user interface configured to: receive a command to conduct a transaction, and communicate the updated reward account information in response to the received reward account information.

An embodiment of a system may include a user interface device comprising: a user interface configured to receive a command to conduct a transaction, a processing device coupled to the user interface device, the processing device configured to process transaction in response to a user command, a communication interface configured to receive updated reward account information from a reward account server in response to the processed transaction, and a user interface configured to: receive a command to conduct a transaction, and communicate the updated reward account information in response to the received reward account information. The system may also include a mobile banking server coupled to the user interface device and configured to conduct the transaction between the user interface device and a third party transaction system. Additionally, the system may include a loyalty rewards server comprising: an input interface configured to receive confirmation of the transaction that triggers accrual of a reward unit, a processing device configured to update a reward account in response to the transaction, and an output interface coupled to the user interface device, the output interface configured to notify the holder of the reward account, via the user interface device, that the reward account has been updated.

### DETAILED DESCRIPTION

The following drawings form part of the present specification and are included to further demonstrate certain aspects of the present invention. The invention may be better understood by reference to one or more of these drawings in combination with the detailed description of specific embodiments presented herein.

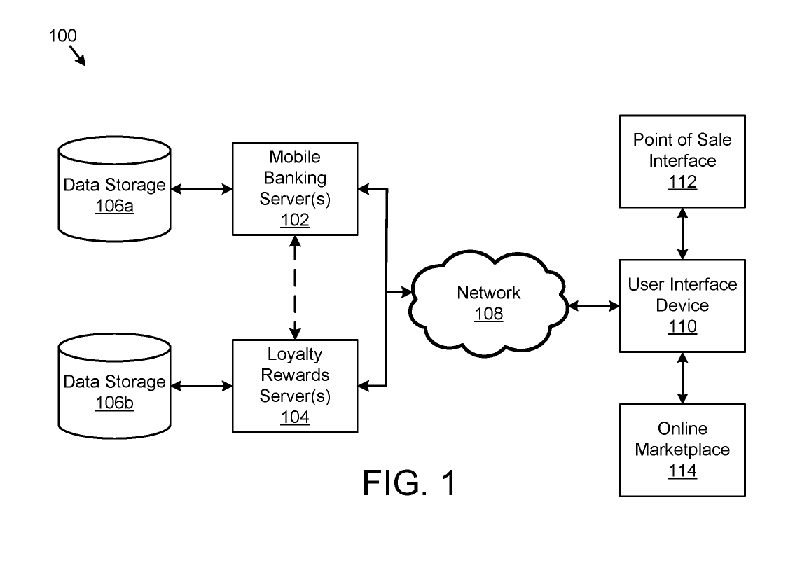

FIG. 1 is a schematic block diagram illustrating one embodiment of a system for mobile purchase rewards.

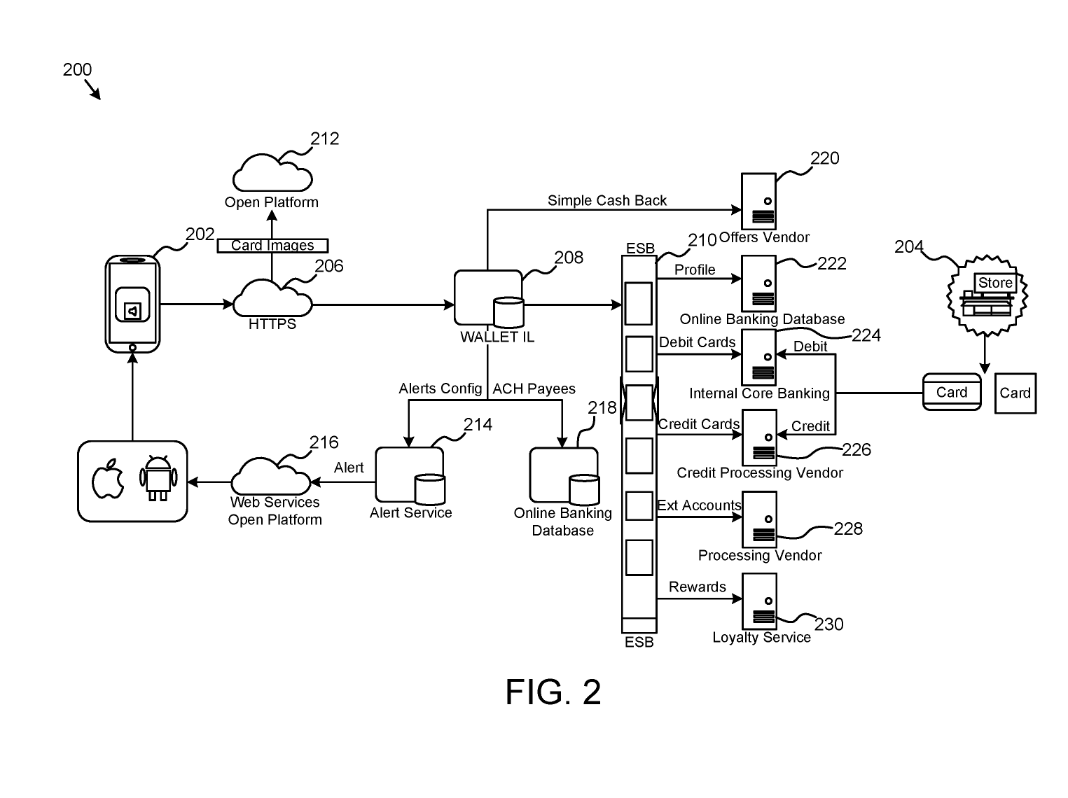

FIG. 2 is a schematic block diagram illustrating one embodiment of a system for mobile purchase rewards.

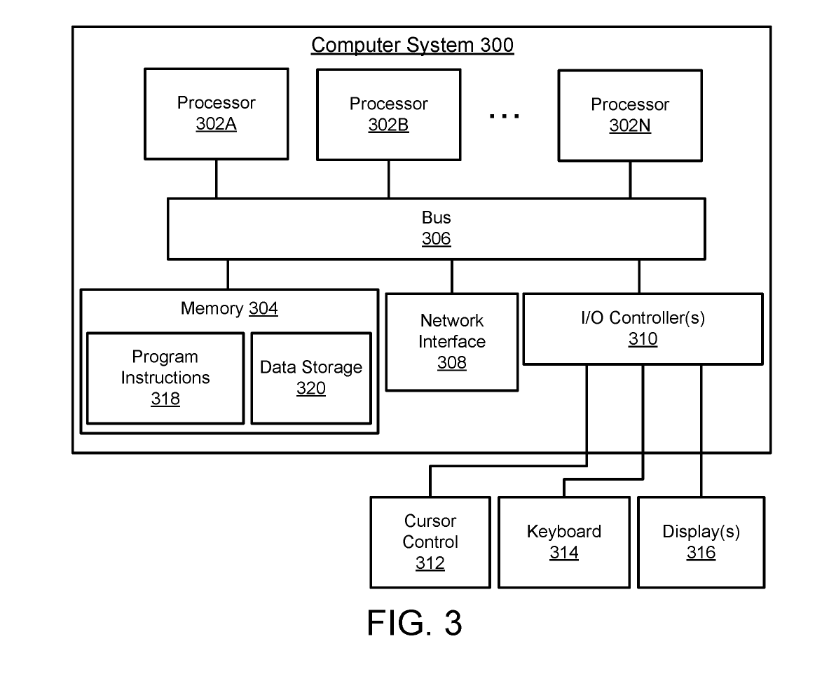

FIG. 3 is a schematic block diagram illustrating one embodiment of a computer system specially configured for mobile purchase rewards.

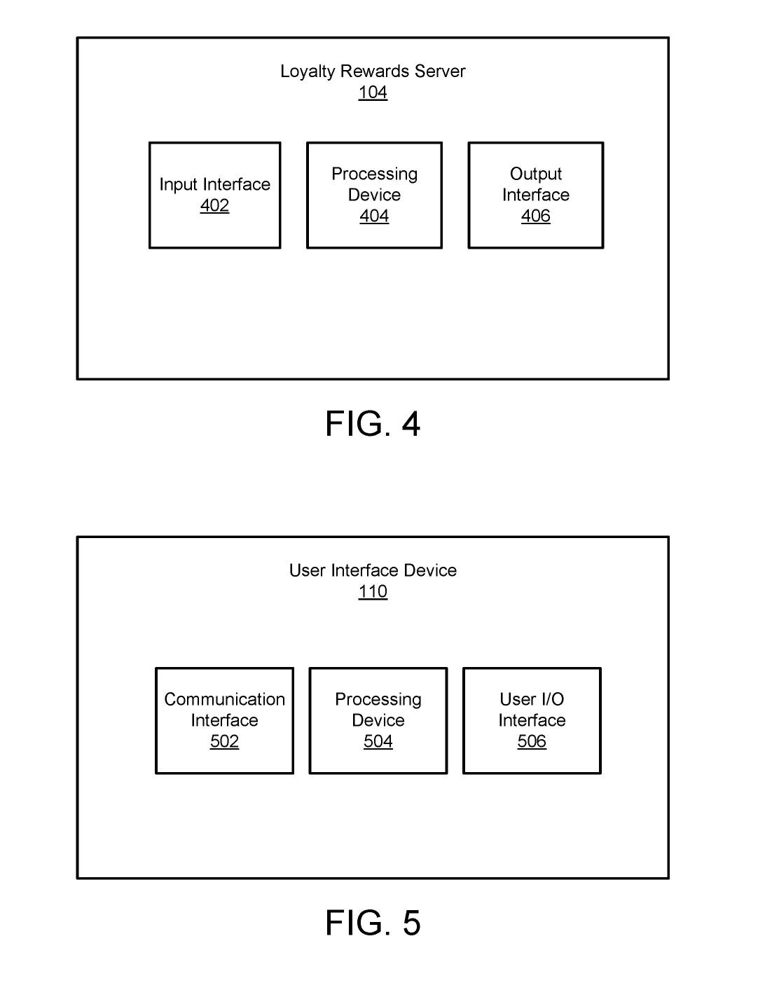

FIG. 4 is a schematic block diagram illustrating one embodiment of an apparatus for mobile purchase rewards.

FIG. 5 is a schematic block diagram illustrating one embodiment of an apparatus for mobile purchase rewards.

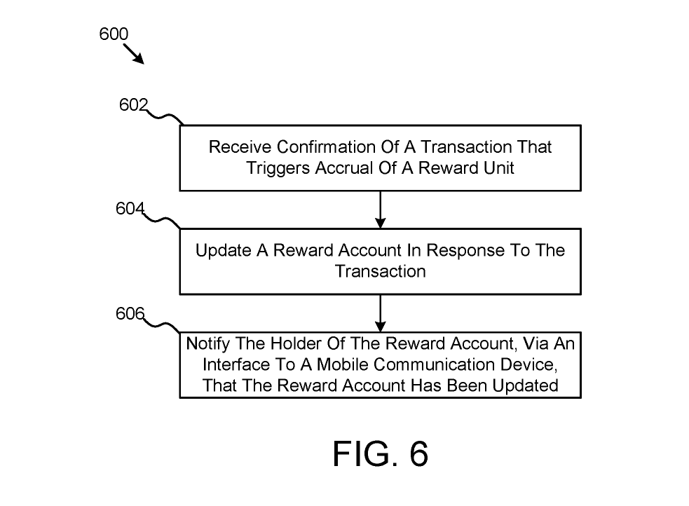

FIG. 6 is a schematic flowchart diagram illustrating one embodiment of a method for mobile purchase rewards.

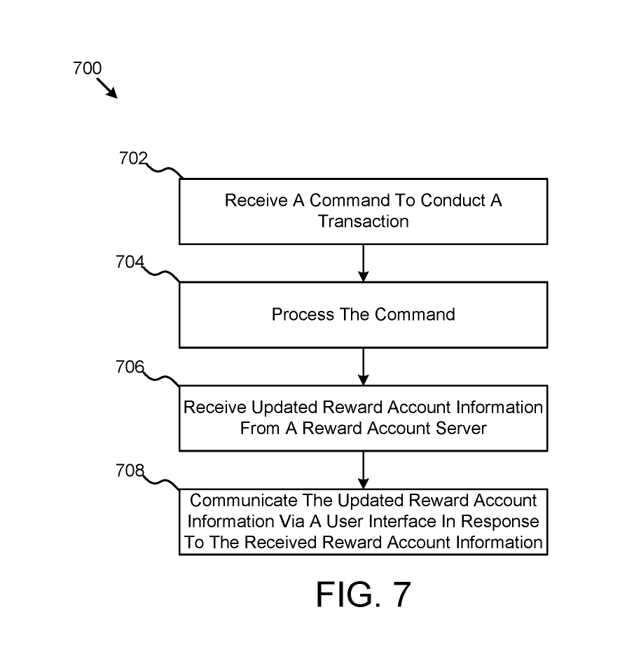

FIG. 7 is a schematic flowchart diagram illustrating one embodiment of a method for mobile purchase rewards.

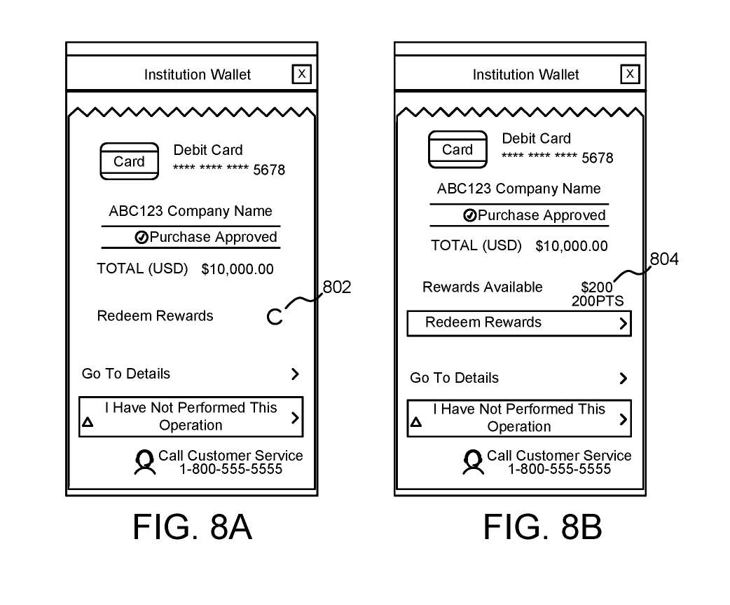

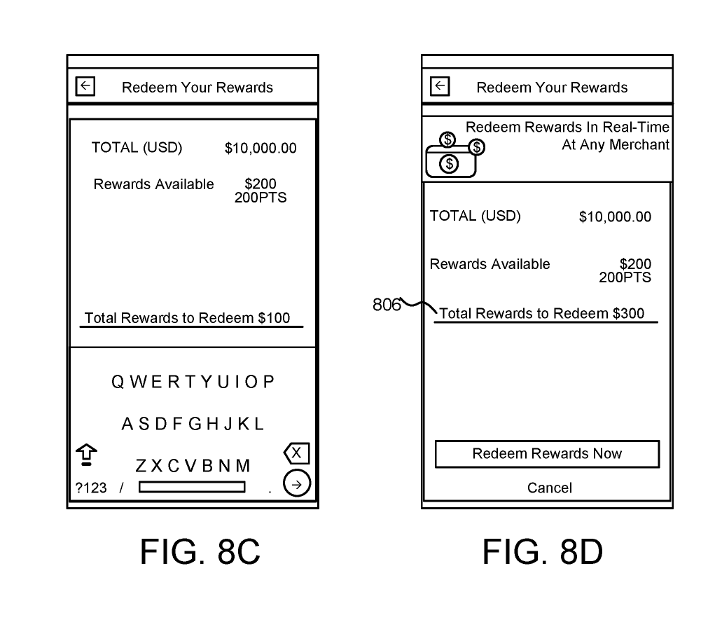

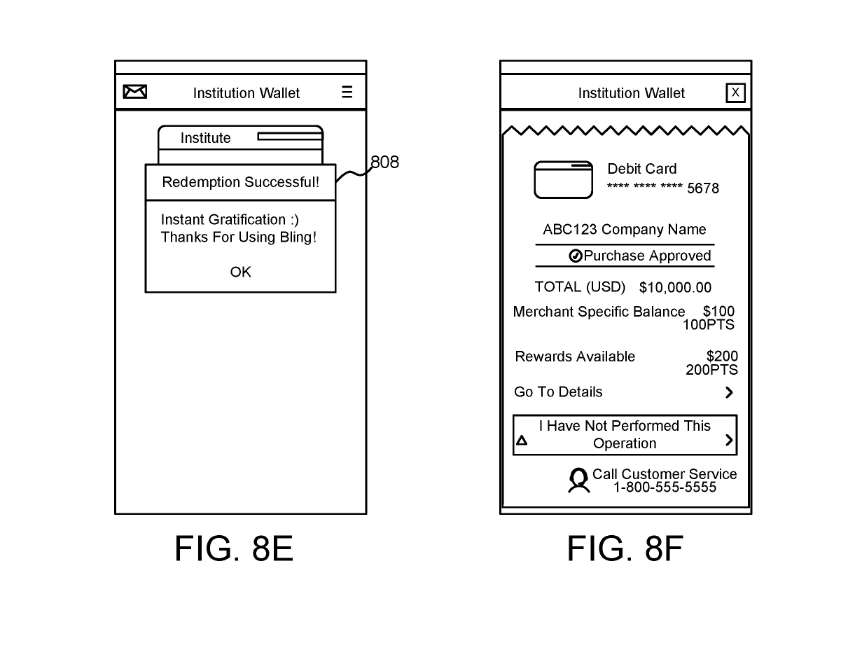

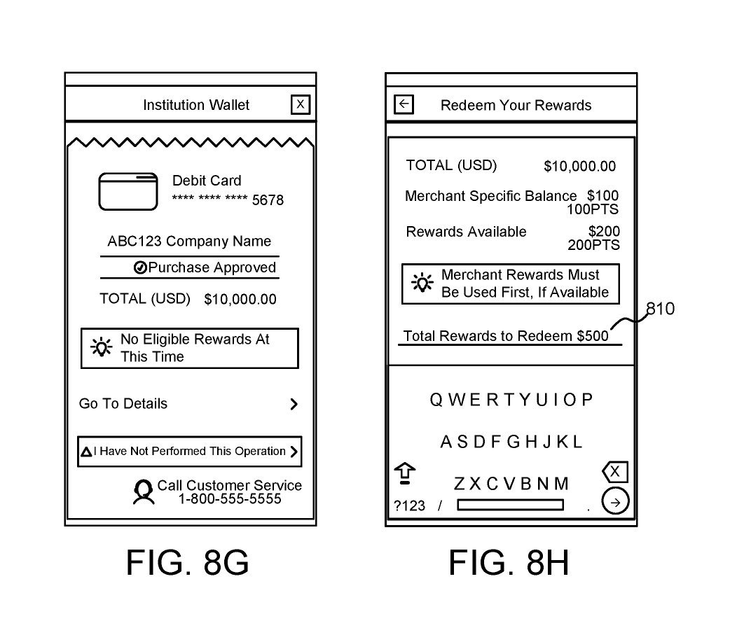

FIG. 8A is a screenshot diagram illustrating one embodiment of a user interface of an application for mobile purchase rewards.

FIG. 8B is a screenshot diagram illustrating one embodiment of a user interface of an application for mobile purchase rewards.

FIG. 8C is a screenshot diagram illustrating one embodiment of a user interface of an application for mobile purchase rewards.

FIG. 8D is a screenshot diagram illustrating one embodiment of a user interface of an application for mobile purchase rewards.

FIG. 8E is a screenshot diagram illustrating one embodiment of a user interface of an application for mobile purchase rewards.

FIG. 8F is a screenshot diagram illustrating one embodiment of a user interface of an application for mobile purchase rewards.

FIG. 8G is a screenshot diagram illustrating one embodiment of a user interface of an application for mobile purchase rewards.

FIG. 8H is a screenshot diagram illustrating one embodiment of a user interface of an application for mobile purchase rewards.

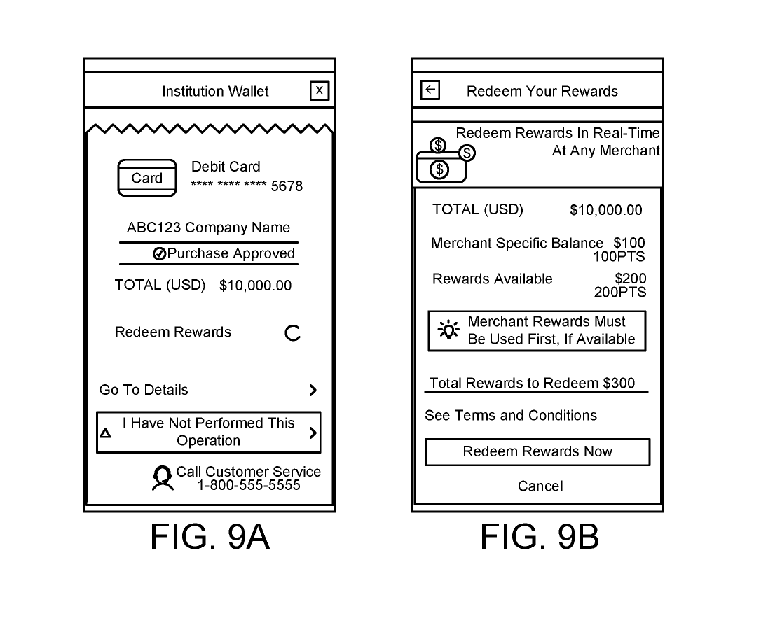

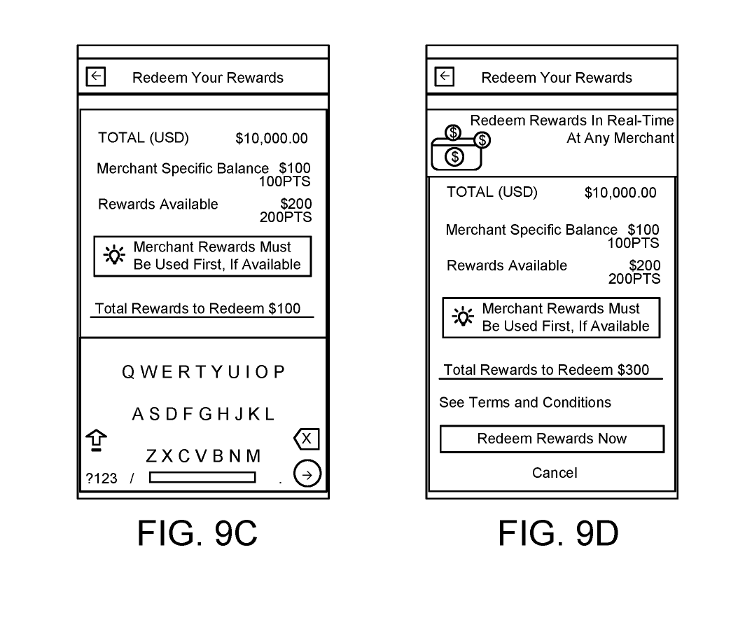

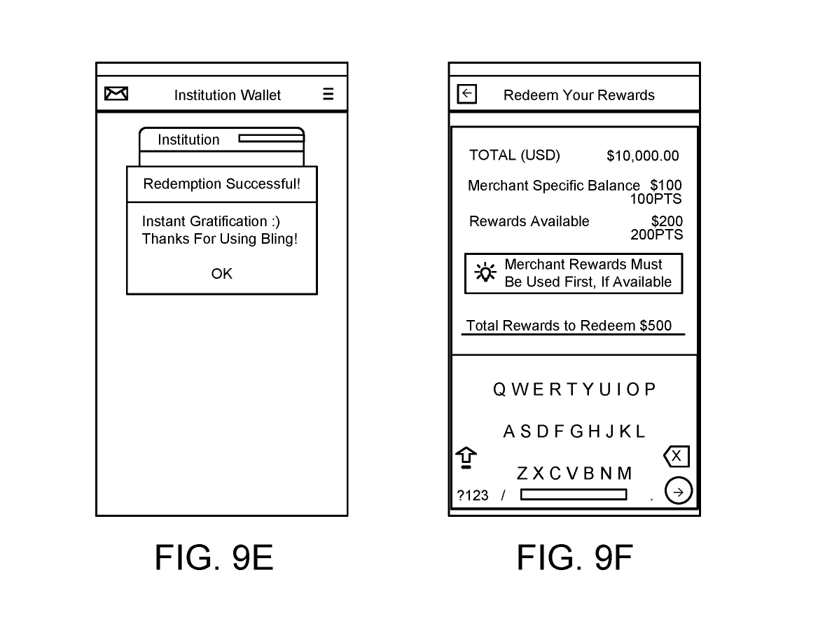

FIG. 9A is a screenshot diagram illustrating one embodiment of a user interface of an application for mobile purchase rewards.

FIG. 9B is a screenshot diagram illustrating one embodiment of a user interface of an application for mobile purchase rewards.

FIG. 9C is a screenshot diagram illustrating one embodiment of a user interface of an application for mobile purchase rewards.

FIG. 9D is a screenshot diagram illustrating one embodiment of a user interface of an application for mobile purchase rewards.

FIG. 9E is a screenshot diagram illustrating one embodiment of a user interface of an application for mobile purchase rewards.

FIG. 9F is a screenshot diagram illustrating one embodiment of a user interface of an application for mobile purchase rewards.

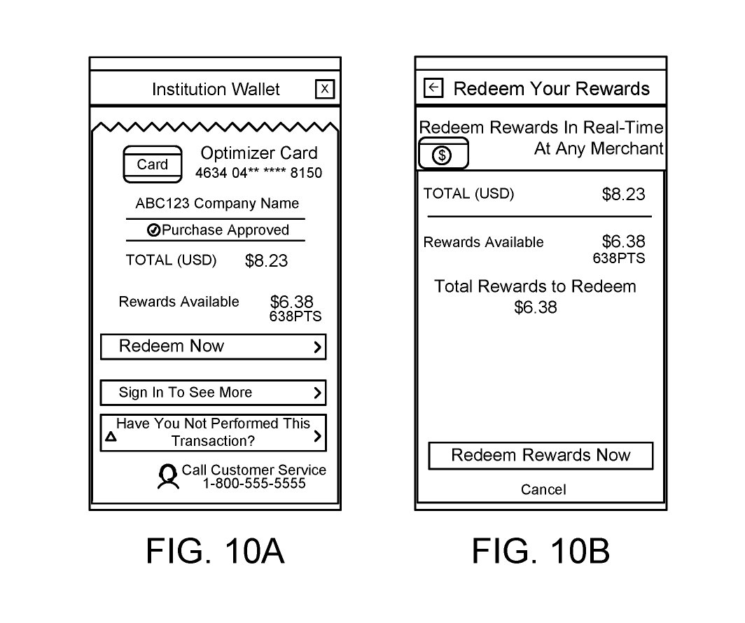

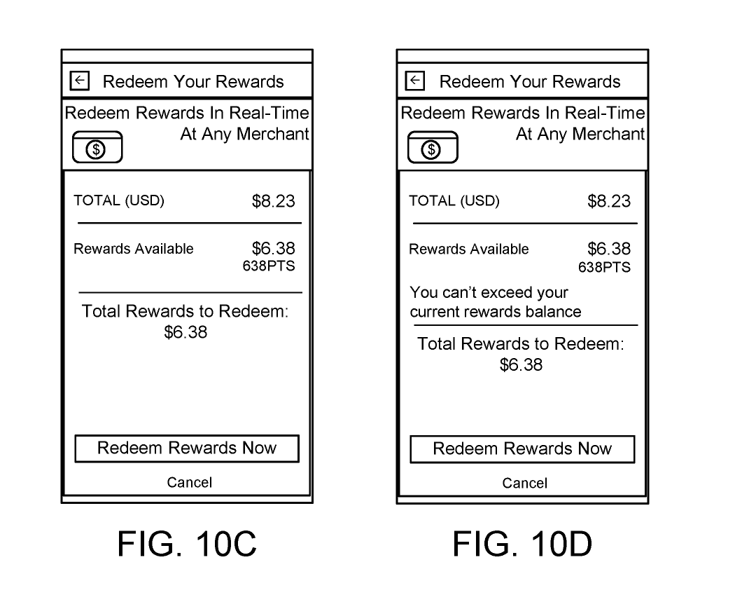

FIG. 10A is a screenshot diagram illustrating one embodiment of a user interface of an application for mobile purchase rewards.

FIG. 10B is a screenshot diagram illustrating one embodiment of a user interface of an application for mobile purchase rewards.

FIG. 10C is a screenshot diagram illustrating one embodiment of a user interface of an application for mobile purchase rewards.

FIG. 10D is a screenshot diagram illustrating one embodiment of a user interface of an application for mobile purchase rewards.

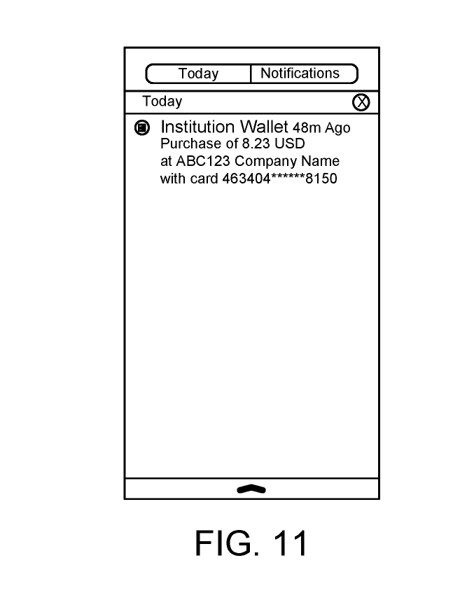

FIG. 11 is a screenshot diagram illustrating one embodiment of a notification from an application for mobile purchase rewards.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

The present embodiments include systems, methods, and apparatuses for mobile purchase rewards. Such embodiments allow a consumer to acknowledge, manage, and facilitate the use of their loyalty value through a mobile transaction application, such as a mobile banking or wallet app on a mobile computing device. The loyalty rewards embedded into the wallet app may include value that is generated through daily use of the credit, debit and/or prepaid card, as well as any merchant offers acquired through affiliated merchant offer programs designed and launched by the primary transaction account institutions.

The present embodiments may better protect the user experience component loyalty rewards programs as they relate to mobile wallet apps. While the market has statement credit capabilities available to their consumers, the present embodiments provide this experience through mobile wallet apps in “near-real time.”

As used herein, the term “near-real time” means the consumer is provided with visibility into their loyalty wallets value via text messages, email, and/or other alerts pushed out from the mobile wallet app as upon notification that the rewards account has been updated. Examples of these messages may include: a message and/or view of entire loyalty value (general and merchant specific buckets), communications that provide insight into expiration of loyalty values, geo location services notifying that participating merchants are near with value disclosed, and communication of offers available based on spend behaviors. In some embodiments, the consumer may be given a set time limit to respond to the message, before the message will expire and the offer is no longer available for the transaction from which the message originated. Thus, the disclosed embodiments provide a broader use of points (or rewards currency) as a form of payment at point of sale and interactive ability and increased functionality to assist in awarding points (or reward currency) at point of sale. In a further embodiment, the transaction may also be matched using the transaction identifier (ID) to the transaction from the processing party in order to credit the account in near real time fashion as a statement credit to the credit card account.

Beneficially, the present embodiments provide the consumer the ability to utilize their points/dollar values in ‘near-real time’ by responding to the message provided. As such, the present embodiments are more streamlined to ensure that consumers have the ability to actively participate in, and realize the value proposition of their payment tool with a financial institution. Currently rewards programs have a low percentage of usage; therefore high breakage. The present embodiments may effectively promote consumer loyalty by encouraging the customer to realize the full potential and value of their rewards program.

FIG. 1 is a schematic block diagram illustrating one embodiment of a system 100 for mobile purchase rewards. In an embodiment, the system 100 includes one or more mobile banking server(s) 102. One of ordinary skill will recognize alternative embodiments that are suitable for other types of transactions, such as travel booking servers, and the like. The mobile banking server(s) 102 may store transaction data on a first data storage device 106a.

The system 100 may also include one or more loyalty rewards server(s) 104. The loyalty rewards server 104 may be configured to maintain a loyalty rewards account associated with a consumer. For example, the consumer may conduct a transaction using a mobile application on a user interface device 110. The user interface device 110 may communicate with a point of sale interface 112, an online marketplace 114, or other marketplaces, such as travel booking sites, or the like. The user interface device 110 and or the point of sale interface 112 or online marketplace 114 may communicate with the mobile banking server 102 and/or the loyalty rewards server 104 over the network 108 to conduct a transaction. In some embodiments, the loyalty rewards server 104 may communicate with the mobile banking server 102 over a separate communication channel.

In such embodiments, the consumer may conduct the transaction with the mobile banking server 102, such as a retail purchase at the point of sale interface 112 or an online purchase at the online marketplace 114. In one embodiment the user interface device 110 may communicate information associated with the transaction to the loyalty rewards server 104 via the network 108. In such an embodiment, the loyalty rewards server 104 may update the consumer's loyalty reward account with value units associated with the transaction details. Information associated with the consumer's loyalty reward account may be stored on a second data storage device 106b. Additionally, the loyalty rewards server 104 may notify the user interface device 110 of the update to the loyalty reward account, and the user interface device 110 may notify the consumer that rewards are available to be claimed and/or redeemed.

In another embodiment, the mobile banking server 102 may notify the loyalty rewards server 104 in response to the transaction, and the loyalty rewards server 104 may automatically update the loyalty rewards account in response to the notification from the mobile banking server 102. In such an embodiment, the loyalty reward server 104 may directly notify the user interface device 110 of the update to the loyalty rewards account, or the loyalty rewards server 104 may communicate the information back to the mobile banking server 102 for further communication to the user interface device 110.

In such embodiments, the notification that the loyalty reward account has been updated may include communication of information over an Application Program Interface (API) or web service to which a mobile wallet app on the user interface device is subscribed. Alternatively, the notification may include a text message, an electronic mail message, or the like. One of ordinary skill will recognize a variety of options for notifying the user interface device 110 of the update to the loyalty rewards account.

One of ordinary skill will further recognize a variety of hardware options and network configurations which may be suitably adapted for use according to the present embodiments. For example, the servers 102, 104 may be physical server devices, or may be cloud-based compute nodes. Additionally, data storage devices 106a-b may be physical storage systems, such as Redundant Array of Independent Disks (RAID) array storage, mainframe storage, or the like. Alternatively, the data storage devices 106a-b may be cloud-based storage, such as shared block storage systems. The servers 102, 106 may be maintained by the financial institution, or may be managed by third-party service providers. Additionally, one of ordinary skill will recognize a variety of user interface devices 110 which may be suitable for use according to the present embodiments, including mobile communication devices such as cellular telephones, smartphone devices, Personal Data Assistants (PDAs), tablet computing devices, laptop devices, wearable communication devices, such as smartwatches, etc.

FIG. 2 is a schematic block diagram illustrating one embodiment of a system for mobile purchase rewards. In an embodiment, a mobile banking app on a smartphone device 202 may conduct a transaction with a retailer 204 using a mobile wallet application. Transaction information may be communicated via network 206. In an embodiment, card images may be communicated to a Credit Card Dashboard Service (CCDS) 212, which houses the images for all credit and debit cards. A Wallet Integration Layer (IL) 208 may provide a medium for importing and exporting transaction data. An Electronic Service Bus (EBS) 210 may route data to correct systems based on standardized rules.

Alert service 214 manages the alerts and events for debit and credit card transactions. In an embodiment, the alert service 214 sends information to the web service 216. The web service 216 may send push notifications to the users device (android or iOS) for debit and credit card transactions. The online banking database 218 may be an online banking integration layer which may be another medium for data importing and exporting.

In an embodiment, the system 200 may include a offers vendor server 220, which may manage simple cash back offers programs. Additionally, the system may include an online banking database 222, which may provide a backend for online banking, mobile banking and mobile wallet. The internal core banking system 224 contains customer and product information. A credit processing vendor server 226 may also be included for issuing and processing credit cards. Further processing vendor server 228 may be a provider for mobile wallet purposes, and may provide the ability to pay your credit card from an account external to the financial institution. The loyalty services server 230 may be a provider for credit card rewards management. Thus, the system 200 of FIG. 2 may include multiple banking servers 102 and/or multiple rewards servers 104.

FIG. 3 is a schematic block diagram illustrating one embodiment of a computer system specially configured for mobile purchase rewards. In one embodiment, mobile banking server(s) 102 may be implemented on a computer system similar to the computer system 300 described in FIG. 3. Similarly, loyalty rewards server(s) 104 may be implemented on a computer system similar to the computer system 300 described in FIG. 3. User interface device 110 may also be implemented on a computer system similar to the computer system 300. In various embodiments, computer system 300 may be a server, a mainframe computer system, a workstation, a network computer, a desktop computer, a laptop, or the like. In other embodiments, computer system 300 may be implemented on a cloud-based datacenter system.

As illustrated, computer system 300 includes one or more processors 302A-N coupled to a system memory 304 via bus 306. Computer system 300 further includes network interface 308 coupled to bus 306, and input/output (I/O) controller(s) 310, coupled to devices such as cursor control device 312, keyboard 314, and display(s) 316. In some embodiments, a given entity (e.g., user interface device 110) may be implemented using a single instance of computer system 300, while in other embodiments multiple such systems, or multiple nodes making up computer system 300, may be configured to host different portions or instances of embodiments (e.g., loyalty rewards server(s) 104).

In various embodiments, computer system 300 may be a single-processor system including one processor 302A, or a multi-processor system including two or more processors 302A-N (e.g., two, four, eight, or another suitable number). Processor(s) 302A-N may be any processor capable of executing program instructions. For example, in various embodiments, processor(s) 302A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 302A-N may commonly, but not necessarily, implement the same ISA. Also, in some embodiments, at least one processor(s) 302A-N may be a graphics processing unit (GPU) or other dedicated graphics-rendering device.

System memory 304 may be configured to store program instructions and/or data accessible by processor(s) 302A-N. For example, memory 304 may be used to store software program and/or database shown in FIGS. 4-7. In various embodiments, system memory 304 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 304 as program instructions 318 and data storage 320, respectively. In other embodiments, program instructions and/or data may be received, sent or stored upon different types of computer-accessible media or on similar media separate from system memory 304 or computer system 300. Generally speaking, a computer-accessible medium may include any tangible, non-transitory storage media or memory media such as electronic, magnetic, or optical media-e.g., disk or CD/DVD-ROM coupled to computer system 300 via bus 306, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 306 may be configured to coordinate I/O traffic between processor 302, system memory 304, and any peripheral devices including network interface 308 or other peripheral interfaces, connected via I/O controller(s) 310. In some embodiments, bus 306 may perform any necessary protocol, timing or other data transformations to convert data signals from one component (e.g., system memory 304) into a format suitable for use by another component (e.g., processor(s) 302A-N). In some embodiments, bus 306 may include support for devices attached through various types of peripheral buses, such as a variant of the Peripheral Component Interconnect (PCI) bus standard or the Universal Serial Bus (USB) standard, for example. In some embodiments, the operations of bus 306 may be split into two or more separate components, such as a north bridge and a south bridge, for example. In addition, in some embodiments some or all of the operations of bus 306, such as an interface to system memory 304, may be incorporated directly into processor(s) 302A-N.

Network interface 308 may be configured to allow data to be exchanged between computer system 300 and other devices, such as other computer systems attached to user interface device 110, for example. In various embodiments, network interface 308 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 310 may, in some embodiments, enable connection to one or more display terminals, keyboards, keypads, touch screens, scanning devices, voice or optical recognition devices, or any other devices suitable for entering or retrieving data by one or more computer system 300. Multiple input/output devices may be present in computer system 300 or may be distributed on various nodes of computer system 300. In some embodiments, similar I/O devices may be separate from computer system 300 and may interact with computer system 300 through a wired or wireless connection, such as over network interface 308.

As shown in FIG. 3, memory 304 may include program instructions 318, configured to implement certain embodiments described herein, and data storage 320, comprising various data accessible by program instructions 318. In an embodiment, program instructions 318 may include software elements of embodiments illustrated in FIGS. 4-7. For example, program instructions 318 may be implemented in various embodiments using any desired programming language, scripting language, or combination of programming languages and/or scripting languages. Data storage 320 may include data that may be used in these embodiments such as, for example, loyalty rewards account information. In other embodiments, other or different software elements and data may be included.

A person of ordinary skill in the art will appreciate that computer system 300 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

FIG. 4 is a schematic block diagram illustrating one embodiment of an apparatus for mobile purchase rewards. More specifically, FIG. 4 illustrates an embodiment of a loyalty rewards server 104. The loyalty rewards server 104 may include an input interface 402, a processing device 404, and an output interface 406. The input interface 402 may receive a confirmation of a completed transaction. In one embodiment, the confirmation may be received from the user interface device 110. In another embodiment, the confirmation may be received from the mobile banking server 102.

The processing device 404 may perform one or more operations in response to the received confirmation. For example, the operations may include generating a reward offer for communication to the user interface device 110. In another embodiment, the operations may include updating a rewards account balance in response to the transaction. Further operations may include determining a value amount by which the rewards account is to be updated in response to the transaction. Additional operations may include determining a type of reward unit to issue in response to the transaction. For example, travel transactions may be rewarded with airline travel points. Retail transactions may be rewarded with retailer-specific rewards, such as in-store credits.

FIG. 5 is a schematic block diagram illustrating one embodiment of an apparatus for mobile purchase rewards. In the embodiment of FIG. 5, the apparatus may be the user interface device 110. The user interface device may be specially programmed to execute a mobile banking app, a travel booking app, or other mobile transaction apps, such as a mobile wallet app. In an embodiment, the user interface device includes a communication interface 502, a processing device 504, and a user Input/Output (I/O) interface 506.

In an embodiment, the communication interface may communicate with the mobile banking server 102 and the loyalty rewards server 104 via network 108. In a further embodiment, the communication interface 502 may also communicate with the point of sale interface 112 and/or the online marketplace 114. In some embodiments, the communication interface may be a mobile data networking card, such as a WiMAX or WiFi networking card. In other embodiments, the communication interface may be a Near Field Communication (NFC) interface, or the like.

The processing device 504 may execute program instructions for a mobile banking app. The processing device may be specially configured to perform operations for conducting a financial transaction, or the like. Additionally, the processing device 504 may be configured to perform operations for receiving notifications and user commands for redeeming loyalty reward units.

The user I/O interface 506 may include a display, such as a touchscreen device. The user I/O interface 506 may also include a Qwerty keyboard, one or more command buttons, or the like. The user I/O interface 506 may communicate alerts from the loyalty reward server 104 indicating that the user's loyalty rewards account has been updated. The user may additionally, enter rewards redemption commands, view rewards account balances, and conduct rewards-based transactions via the user I/O interface 506.

FIG. 6 is a schematic flowchart diagram illustrating one embodiment of a method 600 for mobile purchase rewards. In an embodiment, the method 600 starts at block 602 with receiving confirmation of a transaction that triggers accrual of the reward unit. At block 604, the method includes updating a reward account in response to the transaction. At block 606, the method includes notifying the holder of the reward account, via an interface to a mobile communication device, that the reward account has been updated.

FIG. 7 is a schematic flowchart diagram illustrating another embodiment of a method 700 for mobile purchase rewards. In an embodiment, the method 700 starts at block 702 with receiving a command to conduct a transaction. At block 704, the method 700 includes processing the command. The method 700 also includes receiving updated reward account information from a reward account server at block 706. At block 708, the method 700 includes communicating the updated reward account information via a user interface in response to the received reward account information.

### EXAMPLES

FIGS. 8A-8H illustrate a first use case of the present embodiments. The use case begins when the user receives a transaction alert from a purchase. The system displays a swirling animation 802 until the card's reward points are retrieved as shown in FIG. 8A. The system populates the redeem reward field 804 with either the total reward points and reward amount or transaction amount, whichever is smaller as shown in FIG. 8B. The user may then accept the prepopulated amount or input the desired reward amount. However, the reward amount should not exceed to total transaction amount. In one embodiment, all of the merchant reward must be used before any general rewards may be used as shown in FIG. 8C. In FIG. 8D, the user may redeem the rewards by tapping or clicking the redeem rewards button 806. At FIG. 8E, the system displays a confirmation 808 of reward redemption.

If a user account is not in good standing, for insufficient funds, late payments, or the like, an error may be generated. In such an embodiment, the system may display the user's rewards without redemption button. If a user has less than a minimum threshold value of reward units, the system does not display any rewards as shown in FIG. 8G. If the user input is greater than the total reward amount as shown in FIG. 8H, the user input amount 810 is flagged. For example, the input amount may be changed to the color red, or an error or warning symbol may be displayed. If the user inputs a value that is smaller than the total reward amount, the flag is removed, and the reward redemption process continues.

Some business-specific rules may be implemented and applied to the application process. For example, the general reward redemption amount may not exceed transaction amount according to some embodiments. In other embodiments, all merchant rewards should be redeemed before any general rewards can be redeemed.

FIGS. 9A-F illustrate a second use case. The purpose of this use case is to enable a user to redeem special program rewards and merchant-specific rewards. Some preconditions are required for this use case. For example, a user must have push notifications enabled, and must have registered for a merchant-specific reward program.

The use case is triggered when the user performs a transaction with a card that has an available merchant reward. In such an embodiment, the system displays confirmation of reward acceptance. The use case begins when the user receives a transaction alert from a purchase where a merchant reward can be redeemed. At FIG. 9A, the system displays a swirling animation until the card's special program rewards and merchant rewards are retrieved. At FIG. 9B, the system populates the redeem reward field with either the total rewards (merchant plus special program) or transaction amount, whichever is smaller. At FIG. 9C, the user may accept the prepopulated amount or input the desired reward amount. However, the redemption amount may not exceed to total transaction amount in some embodiments. In one embodiment, all of the merchant reward must be used before any general rewards may be used. When the user taps the rewards redemption button at FIG. 9D, the system may display a confirmation of reward redemption as shown in FIG. 9E. If, the user inputs a value that is larger than the total reward amount, the user input amount is flagged as shown at FIG. 9F. When the user inputs an amount that is smaller than the total reward amount, the flag is removed and the process continues.

FIGS. 10A-D illustrate alternative embodiments of a user interface screen for a of an application for mobile purchase rewards. FIG. 10A illustrates an alternative embodiment of a rewards calculation, where rewards from a purchase are immediately available for redemption. In such an embodiment, the rewards may be redeemable in real-time at any merchant, as shown in FIG. 10B. If, at FIG. 10C, the user attempts to use rewards for a purchase that exceeds the current rewards balance, the user may be notified of the error, as shown at FIG. 10D. In one embodiment, the user may use up to the total rewards balance available, and provide further payment of the balance. In another embodiment, the user may be notified that the rewards transaction cannot be completed. One of ordinary skill will recognize that various alternative embodiments may be implemented in keeping with the spirit of the present embodiments.

In an embodiment, as illustrated in the screenshot of FIG. 11, the present embodiments may generate user notifications. In the embodiment of FIG. 11, the mobile application may generate a push notification for display on a user interface. The push notification may include information about the recent transaction and/or the rewards available. Alternative embodiments of notifications may include text or SMS messages, email message, automated telephone calls, etc.

Although the invention(s) is/are described herein with reference to specific embodiments, such as screenshots of actual mobile transaction rewards program interfaces, various modifications and changes can be made without departing from the scope of the present invention(s). Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
receiving confirmation of a transaction that triggers accrual of a reward unit at a processing device;
updating a reward account in response to the transaction using the processing device; and
notifying the holder of the reward account, via an interface to a mobile communication device, that the reward account has been updated.

2. The method of claim 1, further comprising crediting a user's account within a 24 hour period by utilizing a transaction identifier (ID) from the transaction in which a reward was redeemed.

3. The method of claim 2, wherein credit is posted by matching the transaction ID of the purchase with the reward request in order to produce a 24 hour or less period from redemption to credit

4. The method of claim 1, wherein the mobile communication device is configured to operate according to instructions of a mobile banking application.

5. The method of claim 4, wherein the mobile banking application comprises a mobile wallet application configured to facilitate purchases via the mobile communication device.

6. The method of claim 4, wherein notifying is performed via a graphical user interface screen of the mobile banking application.

7. The method of claim 4, wherein notifying is performed via a push notification from the mobile banking application.

8. The method of claim 1, wherein notifying comprises sending a text message to the mobile communication device.

9. The method of claim 1, wherein notifying comprises sending an electronic mail message.

10. The method of claim 1, further comprising prompting the holder of the account to redeem the accrued reward units via the mobile communication device.

11. The method of claim 10, further comprising communicating confirmation of reward redemption in response to the account holder redeeming accrued reward units via the mobile communication device.

12. A method comprising:
receiving, at a user interface of a mobile communication device, a command to conduct a transaction;
processing the command at a processing device coupled to the user interface;
receiving updated reward account information from a reward account server over a communication interface; and
communicating the updated reward account information via a user interface in response to the received reward account information.

13. The method of claim 12, further comprising crediting a user's account within a 24 hour period by utilizing a transaction identifier (ID) from the transaction in which a reward was redeemed.

14. The method of claim 13, wherein credit is posted by matching the transaction ID of the purchase with the reward request in order to produce a 24 hour or less period from redemption to credit

15. The method of claim 12, further comprising sending a confirmation of the transaction to a remote reward account server via a communication interface coupled to the processing device.

16. The method of claim 12, further comprising receiving, at the user interface, a command to redeem reward units from the reward account.

17. The method of claim 14, further comprising processing the command to redeem the reward units.

18. The method of claim 15, further comprising communicating information, in response to the command to redeem reward units, to the reward account server.

19. The method of claim 16, further comprising receiving updated reward account information in response to the redeemed reward units.

20. A system comprising:
a user interface device comprising:
a user interface configured to receive a command to conduct a transaction;
a processing device coupled to the user interface device, the processing device configured to process transaction in response to a user command;
a communication interface configured to receive updated reward account information from a reward account server in response to the processed transaction; and
a user interface configured to:
receive a command to conduct a transaction; and
communicate the updated reward account information in response to the received reward account information;
a mobile banking server coupled to the user interface device and configured to conduct the transaction between the user interface device and a third party transaction system; and
a loyalty rewards server comprising:
an input interface configured to receive confirmation of the transaction that triggers accrual of a reward unit;
a processing device configured to update a reward account in response to the transaction; and
an output interface coupled to the user interface device, the output interface configured to notify the holder of the reward account, via the user interface device, that the reward account has been updated.
